(19) United States
(12) Patent Application Publication
(10) Pub. No.: US 2005/0155184 A1
(43) Pub. Date: Jul. 21, 2005

(54) Mobile computer hinge assembly

(76) Inventor: Paul R. Kayl, McCook Lake, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/758,891

(22) Filed: Jan. 16, 2004

(51) Int. Cl. E05D 3/06

(52) U.S. Cl. 16/366

(57) ABSTRACT

An apparatus and method which allows a mobile display panel to rotate substantially 360 degrees is provided. In one embodiment, the mobile computer hinge assembly allows the mobile display panel to rotate from a closed position through a first operative position into a second operative position. With the lid in the second operative position, the mobile computer can now be docked to a docking station in an upright position, thus saving desk space and also allowing the mobile display to be used as a flat panel display, thus eliminating the need for a desktop monitor. With the lid in the second operative position, the computer can also now be used as a tablet computer. In this embodiment, the mobile display is a touchpad display.

### FIELD

This invention relates generally to mobile computer systems and more particularly to a mobile computer hinge assembly.

### BACKGROUND

Mobile computer system users are increasingly demanding more flexibility in the manner in which they configure and operate their laptop computers. For example, many mobile users often dock their unit for use as a desktop system. However, most docked mobile foot prints are quite large, particularly for users who prefer to use a desktop keyboard and mouse. Many users also have a monitor on their desk in addition to the mobile system, taking up even more space. As a result, there is little or no flexibility in one's ability to arrange the docked system.

Tablet computers are also popular with many mobile computer system users. Tablet computers combine input and display into a single tablet format. This provides a computer that has the familiarity of a tablet of paper, providing a convenient transition from the paper tablet to a computer which is much more versatile. There is a need for a device that combines the benefits of a mobile computer system with a tablet computer.

Thus, there is a need for providing improved mobile computer systems.

### SUMMARY

An apparatus and method which allows a mobile display panel to rotate substantially 360 degrees is provided. In one embodiment, the apparatus is a mobile computer hinge assembly comprising a first hinge mountable to an outer vertical surface of a mobile computer lid; a second hinge mountable to an outer vertical surface of a mobile computer chassis; and a connecting member connectable to the first hinge and to the second hinge wherein the lid is rotatable substantially 360 degrees from a closed position through a first operative position into a second operative position when the hinge assembly is mounted to the outer surface of the lid and the outer surface of the chassis.

In another embodiment, the apparatus is an electronic device comprising a notebook computer having a chassis and a lid, the chassis containing at least one chassis hinge channel and the lid containing at least one lid hinge channel; at least one first hinge mounted in the one lid hinge channel; at least one second hinge mounted in the at least one chassis hinge channel of the chassis; and at least one connecting member connecting each of the at least one first hinge to each of the at least one second hinge wherein the lid is rotatable substantially 360 degrees from a closed position through a first operative position into a second operative position.

In one embodiment, the apparatus is a system comprising a notebook computer having a display; and one or more dual pivot hinge assemblies connected to the notebook computer wherein the one or more dual pivot hinge assemblies allows the display to rotate to a back side of the notebook computer.

When the lid is in the closed position, the display panel is on top of and facing towards the chassis. When the lid is in the first operative position, the display panel is angled for viewing by a user of the mobile computer system. When the lid is in the second operative position, the display panel is underneath and facing away from the chassis.

With the lid in the second operative position, the computer can now be used as a tablet computer. In this embodiment, the mobile display is a touchpad display. With the lid in the second operative position, the mobile computer can also now be docked to a docking station in an upright position, thus saving desk space and also allowing the mobile display to be used as a flat panel display, thus eliminating the need for a desktop monitor.

### BRIEF DESCRIPTION OF THE DRAWINGS

FIG. 1 is a simplified side view of a mobile computer containing a chassis and lid connected together with two hinge assemblies (one shown); with the lid shown in a closed position (A), first operative position (B) and second operative position (C) in embodiments of the present invention.

FIG. 2A is a simplified back view of a mobile computer having two hinge assemblies located in channels, with the lid in a closed position in one embodiment of the present invention.

FIG. 2B is a top view of the mobile computer shown in FIG. 2A in one embodiment of the present invention.

FIG. 3 is a simplified perspective view of the mobile computer shown in FIG. 2A with the display panel rotated substantially 360 degrees to a second operative position in one embodiment of the present invention.

FIG. 4 is a simplified front view of the mobile computer shown in FIG. 3 in the second operative position, vertically docked to a docking station in one embodiment of the present invention.

FIG. 5 is a simplified top view of the mobile computer shown in FIG. 3 in the second operative position, being used as a tablet computer in one embodiment of the present invention.

### DETAILED DESCRIPTION

In the following detailed description of embodiments of the invention, reference is made to the accompanying drawings that form a part hereof, and in which is shown by way of illustration specific exemplary embodiments in which the subject matter may be practiced. These embodiments are described in sufficient detail to enable those skilled in the art to practice them, and it is to be understood that other embodiments may be utilized and that mechanical, structural, electrical, and logical changes may be made without departing from the spirit and scope of the present subject matter. The following detailed description is, therefore, not to be taken in a limiting sense, and the scope of embodiments of the present invention is defined only by the appended claims.

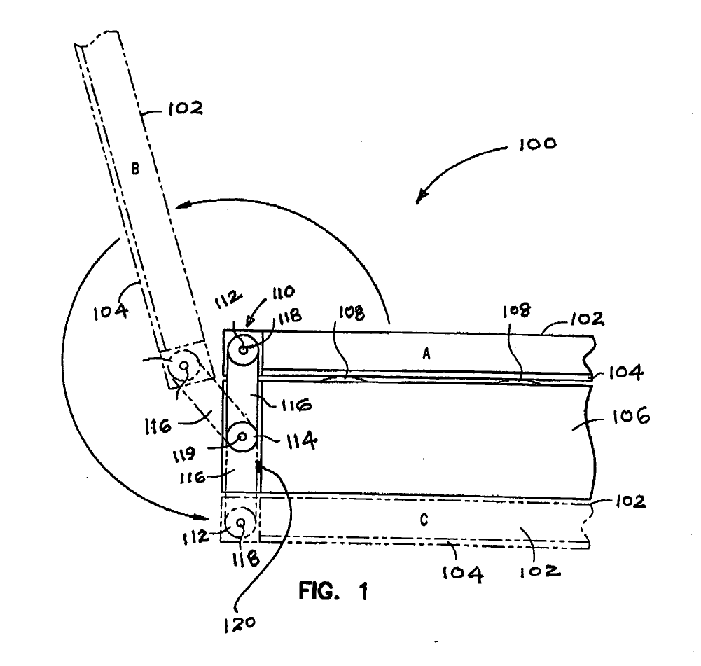

FIG. 1 shows a mobile electronic device 100 containing a chassis 101 and lid 102 connected together with two novel hinge assemblies 110 (only one shown). The lid 102 includes a display panel 104 and a cover portion 105. The chassis 101 has a top surface 103 and centerline 130 as shown and further contains two feet 108 and a pressure switch 120.

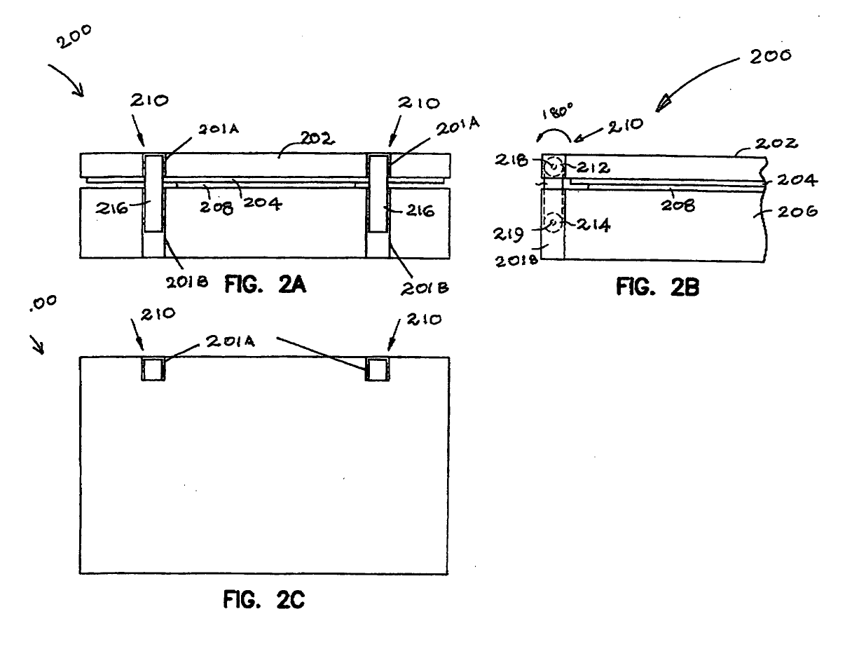

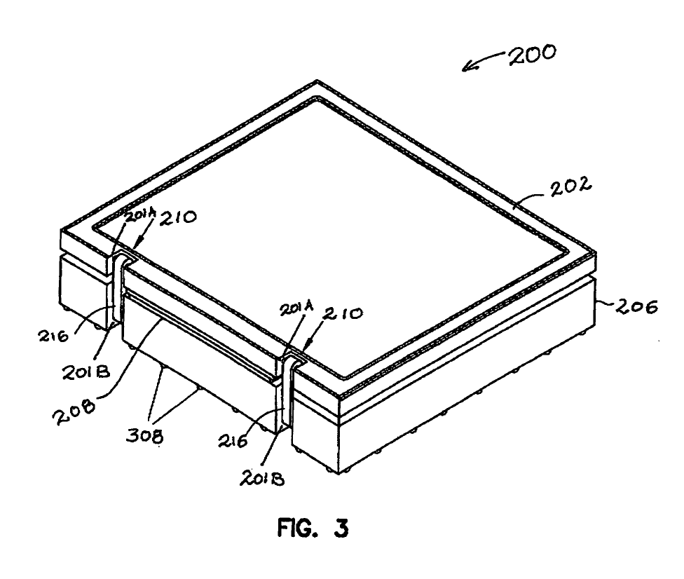

In the embodiment shown in FIG. 1 one novel hinge assembly 110 is attached on either side of the electronic device 100, although the invention is not so limited. Any number of novel hinge assemblies 110 can be secured in any suitable location to the mobile electronic device 100, as long as the lid 102 is properly secured and able to rotate up to 360 degrees, e.g., position “C”. For example, in one embodiment a single novel hinge assembly 110 can be secured to the back of the mobile electronic device 100 at about the midpoint, although additional hinge assemblies 110 may provide needed support. In another embodiment, two novel hinge assemblies 110 are secured to the back of a mobile electronic device 200 (See FIG. 2A). In yet other embodiments more than two novel hinge assemblies 110 are used in any location. Hinge assemblies 110 secured to the back of a mobile electronic device may each be located inside a channel which extends through the chassis 101 and lid 102. Preferably, such a channel is sufficiently large so that each hinge assembly 100 is flush with the outer edge of the device, as in FIGS. 2A and 3, or otherwise recessed within the channel a suitable distance. Alternatively, each hinge assembly 110 may be secured in a manner such that it protrudes outwardly from the device, such as when there are no channels present.

The various components of the hinge assembly 110 can have any suitable configuration as is known in the art. In most embodiments each hinge has a pivot mechanism, such as a pin. In most embodiments, the hinge assembly 110 further contains a locking positioner (not shown) to keep the lid 102 in a particular position. In the embodiment shown in FIG. 1, each hinge assembly 110 is a dual-pivot hinge assembly comprised of a first hinge 112 mounted to the lid 102 with a first hinge pivot mechanism 118, a second hinge 114 mounted to the chassis 101 with a second hinge pivot mechanism 119, and a connecting member 116 which joins the first hinge 112 and second hinge 114 together into one operative unit. Preferably, the first hinge pivot mechanism 118 hinges along a line-which may be referred to as a pivot line—which is parallel to the line along which the second hinge pivot mechanism 119 hinges.

In addition to connecting the chassis 101 and lid 102 together, the hinge assemblies 110 further allow the lid 102 to be opened and closed in order to allow access to a keyboard and mouse (not shown) located on the top surface 103 of the chassis 101. Each novel hinge assembly 110 is also designed and located to allow the lid 102 to rotate up to 360 degrees from a closed position (A) through a first operative position (B) into a second operative position (C) as shown in FIG. 1. Each connecting member 116, as well as each second hinge 114, however, can only rotate up to 180 degrees, although each first hinge 112 can rotate up to 360 degrees. It is important to note that no portion of the hinge assembly 110 should be installed on the top surface 103 of the chassis 101 as this will prevent the lid 102 from fully rotating up to 360 degrees. The first hinge 112 of each hinge assembly 110 is typically installed nearest the bottom edge of the lid 102, although, in most embodiments, the first hinge 112 extends through nearly the entire height of the lid 102. Additionally, the pivot mechanism 119 of the second hinge 114 should not be centered above or below the centerline 130 of the chassis 102 as this will also prevent the lid 102 from fully rotating. However, as long as the pivot mechanism 119 of the second hinge 114 is centered substantially on the centerline 130 of the chassis 101, the lid 102 should be able to fully rotate up to 360 degrees.

In most embodiments, the mobile electronic device 100 is a mobile computer system, e.g., mobile computer, as is known in the art, which is often referred to as a “laptop” or “notebook” computer. When the lid 102 of the mobile electronic device 100 is in the closed position (A), the display panel 104 is on top of and facing towards the chassis 101 as shown in FIG. 1. When the lid 102 is in the first operative position (B), the display panel 104 is angled for viewing by a user of the mobile electronic device 100 as shown in FIG. 1. This angle is usually about 80 to 90 degrees or more in relation to the chassis 101, typically no more than about 150 degrees, depending on the user's preference, lighting conditions, and so forth. When the lid 102 is in the second operative position (C), the display panel 104 is underneath and facing away from the chassis 101 as shown in FIG. 1. Additionally, the pressure switch 120, which serves to disable the keyboard and mouse, is activated by direct contact with the connecting member 116 when the lid 102 is in the second operative position (C). Any suitable device known in the art can be used as the pressure switch 120.

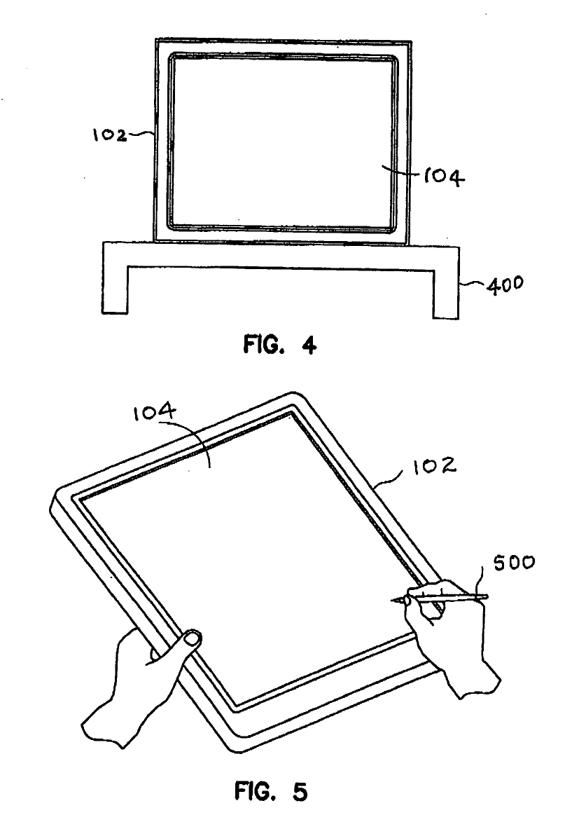

With the lid 102 in the second operative position (C), the mobile electronic device 100 can now be docked to a docking station in an upright position, thus saving desk space and also allowing the display panel 104 to be used as a flat panel display, thus eliminating the need for a desktop monitor (See FIG. 4).

With the display panel 104 in the second operative position (C), the mobile electronic device 100 can also now be used as a tablet computer (See FIG. 5). In this embodiment, the display panel 104 is a touchpad display. A tablet computer, often referred to as a “tablet PC” is a type of electronic device that includes a touch screen which accepts input via an instrument, such as a stylus or a finger, and allows the user to use the instrument and the touch screen much as the user would use a pen and paper. Some tablet computers perform handwriting recognition using the trace of the instrument on the touch screen, and some tablet computers merely store the traces made by the instrument without performing handwriting recognition. Thus, a tablet computer may provide the user with the ability to take notes or draw pictures using a pen-like instrument without needing to type on a keyboard.

The feet 108 shown in the embodiment in FIG. 1 function as “separators” to prevent the chassis 101 from contacting a work surface when the lid 102 is in the second operative position (C) and the electronic device 100 is being used as a tablet PC. In the embodiment shown in FIG. 1, the feet 108 are rounded in shape and secured towards the outer edges of the top surface 103 of the chassis 101, although the invention is not so limited. Such separators can take on any suitable configuration and be installed in any suitable location, typically on the top surface 103 of the chassis 101, as long as they are capable of performing the intended function. However, the separators should be designed to ensure there is no interference with the ability of the lid 102 to close properly or with the use of the keyboard and/or mouse when the lid 102 is in the first operative position (B).

In one embodiment, a single separator is used. In another embodiment one or more separators, each comprised of a ridge (208) located towards the outer edges of the top surface 103 of the chassis 101 are used (See FIG. 2A). In another embodiment, multiple separators comprised of a series of small dimples (308) located along outer two or more outer edges of the top surface 103 of the chassis 101 are used (See FIG. 3). The separators can be made from any suitable material and secured in any suitable manner. In one embodiment the separators are made from rubber and secured with a suitable adhesive material.

The mobile electronic device 100 may further include a single processor or multiple processors, a storage device and a docking connector, in addition to the display panel 104 (e.g., screen) shown in FIG. 1, all connected via a single bus or multiple buses, respectively, as is known in the art. The storage device may include a controller, a scratchpad application, and a telephone message pad application as is also known in the art. The processor may represent a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor typically includes a control unit that organizes data and program storage in memory and transfers data and other information between the various parts of the mobile electronic device 100. When used as a tablet PC, the processor may receive input data from the display panel 104, may read and store code and data in the storage device and may present data via the display panel 104. Other features particular to tablet computers are known in the art and will not be described in further detail herein.

As noted above, any number of hinge assemblies 110 can be used in any suitable location. FIG. 2A shows an alternative mobile electronic device 200 in which the two hinge assemblies 110 are each installed in channels, each channel comprised of a lid hinge channel 203A and a chassis hinge channel 203B in vertical alignment with one another. Together, each lid hinge channel 203A and chassis hinge channel 203B combination accommodates one hinge assembly 110 as shown. As with the embodiment shown in FIG. 1, the first hinge 112 of each hinge assembly 110 is typically installed nearest the bottom edge of the lid 102 (in this instance, the back side of the lid 102) although, in most embodiments, the first hinge 112 extends through nearly the entire height of the lid 102. Again, the pivot mechanism 119 of the second hinge 114 of each hinge assembly 110 is substantially centered on the chassis centerline 230. With the hinge assemblies 110 in these positions, together with the use of the lid hinge channel 203A and chassis hinge channel 203B, each hinge remains flush with its respective portion (lid 102 or chassis 101) regardless of its position. In alternative embodiments, there are no channels and the hinge assemblies are not flush with the device.

In this embodiment the separators are comprised of ridges 208 (one shown) secured to the top surface of the chassis 101 near two or more edges, such as near the back edge, although the invention is not so limited. Any type of appropriate separator can be used in any of the embodiments described herein. In an alternative embodiment, there are two ridges 208, each located only along an outer side edge of the top surface 103 of the chassis 101.

FIG. 2B provides an additional top view of the embodiment shown in FIG. 2A. In this embodiment, the lid hinge channels 203A extend through to the top of the lid 102, although the invention is not so limited. In other embodiments, the lid hinge channels 203A are not visible from the top of the lid 102.

While FIG. 2A shows the lid 102 in a closed position (Position “A” in FIG. 1), FIG. 3 provides a perspective view of the same device with the lid 102 in the second operative position (Position “C” in FIG. 1). The mobile electronic device 200 is now ready for use as either a tablet PC or as a desktop display, described further in FIGS. 4 and 5. Although in this embodiment, the hinge assemblies 110 are flush with the back of the chassis 101 and lid 102 as described above, in an alternative embodiment, each hinge assembly 110 is recessed any suitable distance into its respective channel portion, e.g., the lid hinge channel 203A and chassis hinge channel 203B. Additionally, in this embodiment, the separators are comprised of a series of dimples 308, some of which might be visible as shown, although again, any type of separator can be used in any of the embodiments described herein.

FIG. 4 shows the device 200 of FIG. 3 vertically docked to a docking station 400 for use as a monitor, although the device 100 of FIG. 1 can also be used in the same manner when the lid 102 is in the second operative position (C). Also, although the device 200 is shown docked with the longer edge secured to the docking station 400, in practice, the device 200 can also be secured to the docking station 400 along its shorter edge. As known in the art, a docking station 400 is used in order to use devices not included within the mobile electronic device. This includes, but is not limited to, a telephone (e.g., hard-wired or wireless telephone, modem-based, etc.), keyboard, display (e.g., cathode-ray tube (CRT), liquid crystal display (LCD), gas, plasma-based, flat-panel, etc.) or any other appropriate device such as a CD-ROM, a printer, a network, speakers, mouse, and the like.

FIG. 5 shows the device 200 of FIG. 3 in use as a tablet PC. In this embodiment the surface of the display panel 104 is used as a touch-pad display together with a writing device 500 as shown.

The novel hinge assembly of the present invention provides flexibility to mobile computer users by allowing the same device to be used either as a mobile computer, a tablet PC or a desktop monitor. By properly locating the hinge assembly as described herein, there is no adverse impact to the size of the display. This is because the hinge assembly is not attached to the top surface of the chassis, but rather to the back (or side) surfaces of the lid and chassis. Additionally the hinge assembly is oriented substantially vertically (rather than substantially horizontally) when the lid is in the closed position, and remains in a substantially vertical position when the lid is in the second operative position. The hinge assembly is further not used as a part of the working apparatus, e.g., speaker, etc., so can remain a relatively simple design.

Although specific aspects have been illustrated and described herein, it will be appreciated by those of ordinary skill in the art that any arrangement that is calculated to achieve the same purpose may be substituted for the specific embodiment shown. This application is intended to cover any adaptations or variations of the present invention. Therefore, it is manifestly intended that this invention be limited only by the claims and the equivalents thereof.

1. A mobile computer hinge assembly comprising:
a first hinge mountable to an outer vertical surface of a mobile computer lid;
a second hinge mountable to an outer vertical surface of a mobile computer chassis; and
a connecting member connectable to the first hinge and to the second hinge wherein the lid is rotatable substantially 360 degrees from a closed position through a first operative position into a second operative position when the hinge assembly is mounted to the outer surface of the lid and the outer surface of the chassis.

2. The assembly of claim 1 wherein the second hinge has a pivot mechanism substantially centered on a chassis centerline.

3. The assembly of claim 1 wherein the outer vertical surface of the lid is a lid side surface and the outer edge of the chassis is a chassis side surface.

4. The assembly of claim 1 wherein the outer vertical surface of the lid is a lid back surface and the outer vertical surface of the chassis is a chassis back surface.

5. The assembly of claim 4 wherein the lid back surface contains a lid hinge channel into which the first hinge is secured and the chassis back surface contains a chassis hinge channel into which the second hinge is secured, further wherein the two channels are in alignment with each other.

6. The assembly of claim 5 wherein the hinge assembly is substantially flush with the lid back surface and chassis back surface.

7. The assembly of claim 1 wherein the lid hinge channel is oriented to allow the first hinge to rotate up to 360 degrees.

8. The assembly of claim 7 wherein the chassis hinge channel is oriented to allow the second hinge to rotate up to 180 degrees.

9. The assembly of claim 1 wherein the lid contains a display which faces a top surface of the chassis when the lid is in the closed position, further wherein the display faces a bottom surface of the chassis when the lid is in the second operative position.

10. The assembly of claim 9 wherein the display is angled for viewing by a user of the mobile computer when the lid is in the first operative position.

11. The assembly of claim 9 wherein the mobile computer can be vertically docked to a docking station when the lid is in the second operative position.

12. The assembly of claim 9 wherein the display is a touchpad display and the mobile computer can be used as a tablet computer when the lid is in the second operative position.

13. An electronic device comprising:
a notebook computer having a chassis and a lid, the chassis containing at least one chassis hinge channel and the lid containing at least one lid hinge channel;
at least one first hinge mounted in the one lid hinge channel;
at least one second hinge mounted in the at least one chassis hinge channel of the chassis; and
at least one connecting member connecting each of the at least one first hinge to each of the at least one second hinge wherein the lid is rotatable substantially 360 degrees from a closed position through a first operative position into a second operative position.

14. The electronic device of claim 13 wherein there are two hinge assemblies comprised of two connecting members connecting each of two first hinges with each of two second hinges.

15. The electronic device of claim 14 wherein each hinge assembly is located towards opposing outer edges of the notebook computer.

16. The electronic device of claim 15 further comprising a docking station to which the notebook computer can be connected in a vertical position when the lid is in the second operative position.

17. The electronic device of claim 13 wherein the chassis contains a keyboard and mouse.

18. The electronic device of claim 13 further comprising a pressure switch to disable the keyboard and mouse, the pressure switch located on the back side of the chassis and activated when the lid is in the second operative position.

19. The electronic device of claim 13 further comprising a separator located on the chassis to prevent the chassis from contacting a work surface when the lid is in the second operative position and the chassis is facing the work surface.

20. The electronic device of claim 19 wherein the separator is comprised of two or more rubber pads located along edges of the chassis.

21. The electronic device of claim 19 wherein the separator is comprised of one or more rubber strips located along edges of the chassis.

22. A system comprising:
a notebook computer having a display; and
one or more dual pivot hinge assemblies connected to the notebook computer wherein the one or more dual pivot hinge assemblies allows the display to rotate to a back side of the notebook computer.

23. The system of claim 22 wherein the notebook computer is vertically docked to a docking station when the display is rotated to the back side.

24. The system of claim 22 wherein the display is a touch pad display and the notebook computer is used as a tablet computer when the display is rotated to the back side.

25. The system of claim 22 wherein the notebook computer further comprises a chassis having a separator, the separator adapted to prevent the chassis from contacting a work surface when the display is in the second operative position and the chassis is facing the work surface.
